(19) United States
(12) Patent Application Publication
(10) Pub. No.: US 2025/0220558 A1
(43) Pub. Date: Jul. 3, 2025

(54) ACQUIRING ESSENTIAL SYSTEM INFORMATION BY A SIDELINK REMOTE DEVICE

(71) Applicant: Lenovo (Singapore) Pte. Limited, Singapore (SG)

(72) Inventors: Prateek Basu Mallick, Dreieich (DE); Joachim Löhr, Wiesbaden (DE); Ravi Kuchibhotla, Chicago, IL (US); Karthikeyan Ganesan, Nauheim (DE)

(21) Appl. No.: 18/844,947

(22) PCT Filed: Apr. 21, 2023
(86) PCT No.: PCT/IB2023/054114

§ 371 Date: Sep. 7, 2024

Related U.S. Application Data
(60) Provisional application No. 63/334,072, filed on Apr. 22, 2022.

(51) Int. Cl. H04W 48/14; H04W 88/04; H04W 92/18

(52) U.S. Cl. CPC H04W 48/14; H04W 88/04; H04W 92/18

(57) ABSTRACT

Various aspects of the present disclosure relate to devices and methods for wireless communication using sidelink communication to relay essential system information to a user device that is remote to, and out of a coverage area, of a serving network device. A relay communication device continues to relay essential system information using sidelink communication to a remote communication device while the remote communication device is in a radio resource control connected state, and after the remote communication device transmits a release to the relay communication device from relaying essential system information originating from the serving network device, where the transmittal of the release by the remote communication device to the relay communication device is a requirement for the remote communication device to enter into the radio resource control connected state.

### TECHNICAL FIELD

The present disclosure relates to wireless communications, and more specifically to wireless communication using sidelink communications for distributing essential system information.

### BACKGROUND

A wireless communications system may include one or multiple network communication devices, including network devices, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

In addition to traditional cellular scheduling of wireless communication, recent implementations include communicating in unlicensed spectrum using sidelink communication over a PC5 interface. A UE that is within the coverage area of a base station or network device such as an eNB can act as a relay UE for another UE (“remote UE”) that is inside or outside of the coverage area of the network device. In an example, eNB is an evolved universal mobile telecommunications system terrestrial radio access network (E-UTRAN) as defined by 3^{rd} generation partnership project (3GPP) for RG long term evolution (LTE). The relay UE can perform an evolved ProSe UE-to-Network-Relay protocol to support connection management, system information (SI) delivery, paging, and access control for the remote UE.

### SUMMARY

The present disclosure presents methods, apparatuses, and systems that support wireless communication of essential system information using sidelink communication relayed to a remote user device even after the remote user device transitions to a radio resource control connected state. By maintaining updated essential system information such as system information block type 1 (SIB1), the remote user device is able to acquire and connect to a network device while in the radio resource control connected state.

Some implementations of the method and apparatuses described herein may include receiving essential system information at a remote communication device from a serving network device via a relay communication device. Some implementations may further include communicating, via a transceiver of the remote communication device, with the relay communication device via a sidelink communication channel. In response to the remote communication device transitioning to a radio resource control connected state, the method may further include automatically transmitting, to the relay communication device from the remote communication device, a release from relaying essential system information originating at a serving network device, where transmittal of the release is a requirement for the device to enter into the radio resource control connected state. The method may further include subsequently transmitting, via the relay device to the serving network device, a request for essential system information. The relay communication device and the serving network device are configured to ignore the release from relaying essential system information. Accordingly, while in the radio resource control connected state, the method may further include receiving, via the relay device, a response containing the system essential information from the serving network device.

Some implementations of the method and apparatuses described herein may further include relaying, via a sidelink communication channel, essential system information by a relay communication device. The method may further include receiving, via a transceiver of the relay communication device, a release from relaying, to the remote device, essential system information originating at the serving network device, the release being a required communication from the sidelink-connected remote device when the remote device is transitioning to a radio resource control connected state. The method may further include identifying that the release as one that is required to be transmitted by RRC connected state protocol but is not controlling of a need for essential system information by the remote device. The method may further include subsequently receiving, via the transceiver from the remote device, a request for essential system information. In response to receiving the request, the method may further include ignoring the release from relaying essential system information and relaying the request to the serving network device. The method may further include receiving the essential system information from the serving network device. The method may further include transmitting the essential system information to the remote device, which is in the radio resource control connected state.

### BRIEF DESCRIPTION OF THE DRAWINGS

FIG. 1 illustrates an example of a wireless communications system that supports using sidelink communication to distribute essential system information to remote user devices that are in radio resource control (RRC) connected state, in accordance with aspects of the present disclosure.

FIG. 2 illustrates a messaging diagram between a remote communication device and a relay communication device with continued relaying of essential system information after receiving a release request from the remote communication device, in accordance with aspects of the present disclosure.

FIG. 3 illustrates a messaging diagram between a remote communication device and a relay communication device with continued relaying of essential system information while the remote communication device is in radio resource control connected state by ignoring receipt of a release from the remote communication device, from communicating the essential system information, in accordance with aspects of the present disclosure.

FIG. 4 illustrates a messaging diagram between a remote communication device, a relay communication device, and a serving network device that is enabled to continued sending essential system information while the remote communication device is in radio resource control connected state, in accordance with aspects of the present disclosure.

FIG. 5 illustrates a messaging diagram between a remote communication device, a relay communication device, and a serving network device that are all configured to continue sending essential system information while the remote communication device is in radio resource control connected state, in accordance with aspects of the present disclosure.

FIG. 6 illustrates an example of a block diagram of a user device that utilizes sidelink communication to relay or receive essential system information, in accordance with aspects of the present disclosure.

FIG. 7 illustrates an example of a block diagram of a serving network device that supports sidelink wireless communication that distributes essential system information, in accordance with aspects of the present disclosure.

FIG. 8 illustrates flow diagram presenting a method of wireless communication at a remote communication device that continues to receive essential system information using sidelink communication while in a radio resource control connected state, in accordance with aspects of the present disclosure.

FIG. 9 illustrates flow diagram presenting a method of wireless communication at a relay communication device that continues to relay essential system information using sidelink communication while a remote communication device is in a radio resource control connected state, in accordance with aspects of the present disclosure.

### DETAILED DESCRIPTION

A UE within a coverage area of a fifth generation (5G) new radio (NR) base node (gNB) can act as a relay UE for a remote UE that is either within or outside of the coverage area. The UE-to-network (U2N) relay UE can forward essential system information (SI) to the U2N remote UE via broadcast, groupcast, or dedicated PC5 to radio resource control (RRC) signaling. An example of essential SI is system information block type 1 (SIB1) that carries information relevant when evaluating if a UE is allowed to access a cell and defines the scheduling of other system information. SIB1 also provides radio resource confirmation information and barring information.

According to generally known implementations or proposed implementations, a U2N remote UE can request that certain system information blocks (SIBs) be forwarded by the U2N relay UE over the PC5-RRC connection. The request is made for a list of required SIBs in an sl-Request-SI-List. The U2N Relay UE then acquires and forwards the requested SIBs to the remote UE. However, the remote UE releases the request to the relay UE to forward SIB(s) when the remote UE is entering RRC_Connected state. Having received this release of SIB request, a relay UE no longer forwards the SI to the remote UE. In particular, neither the updates to the requested SIBs nor the SIB1 will be forwarded by the relay UE once the UE enters the RRC_Connected state. In the RRC_Connected state, the remote UE can use the DEDICATEDSIBREQUEST message to request certain SIBs: sib12, sib13, sib14, sib20-v1700, sib21-v1700, spare3, spare2, and spare1.

However, the remote UE cannot request essential SI such as SIB1 using the DEDICATEDSIBREQUEST in the RRC_Connected state. As a result, the remote UE has two unsatisfactory options. First, the remote UE, being unable to receive SIB1 update, may continue to use the version of SIB1 that it has last received before transitioning to RRC_Connected state. As a result, the remote UE may be using stale/invalid configuration. With an invalid configuration, the remote UE may be unable to monitor the radio condition with the serving cell such as using ServingCellConfigCommonSIB message that contains synchronization signal block (SSB) information. Second, the remote UE, being unable to maintain a valid version of SIB1, may consider the remote UE as being barred from using the serving cell.

In multiple embodiments, the present disclosure supports maintaining valid essential system information such as SIB1 at a remote UE that has entered an RRC_Connected state. In one embodiment, a U2N relay UE is configured to continue to forward SIB1 updates to the U2N remote UE irrespective of having received information that indicates the forwarding of SIB1 should cease. In particular, the relay UE continues to forward SIB1 regardless of receiving a RemoteUEInformationSidelink message and without modifying operations based on contents of the message. In another embodiment, a U2N remote UE is configured to not request discontinuing forwarding of essential SI such as SIB1 when entering the RRC_Connected state. In particular, the remote UE does not set sl-Requested-SI-List to the value “release” while transitioning or after transitioning to the RRC_Connected state. In an additional embodiment, a serving UE such as a network device or base station is configured to send SIB1 and its update to all U2N remote UEs. In a further embodiment, a communication system of UEs and network devices are configured to support a DedicatedSIBRequest message can include explicit information allowing a SIB1 request from a U2N remote UE. Each of the embodiments enable the remote UE to maintain accurate essential SI and thereby be able to access a serving UE or network device while using a PC5-RRC connection to a relay UE.

According to aspects of the present disclosure, a method is provided for wireless communication at a remote communication device. The method may include communicating, via a transceiver of the remote communication device, with a relay communication device via a sidelink communication channel. The method includes transmitting, to the relay communication device, a first request for at least one system information block that originates at a serving network device. The method includes receiving, from the relay communication device, the at least one system information block. In response to transitioning to a radio resource control (RRC) connected state, the method may include transmitting, to the relay device, a release from relaying essential system information originating at the serving network device. The method may include transmitting, via the relay device to the serving network device, a second request for at least one system information block. While in the RRC connected state, the method may include receiving, via the relay device, a response containing the at least one system information from the serving network device. In one or more embodiments, the first request for the at least one system information block is a radio resource control message. In one or more embodiments, the second request for the at least one system information block and the response containing the at least one system information block are RRC messages.

According to another aspect of the present disclosure, a method is provided for wireless communication at a relay communication device. The method may include communicating, via a transceiver of the relay communication device, with a serving network device via wireless communication channel. The method may include communicating, via the transceiver of the relay device, with a remote device via a sidelink communication channel. The method may include receiving, from the relay device, a first request for at least one system information block that originates at the serving network device. The method may include transmitting, to the remote device, the at least one system information block received from the serving network device. The method may include receiving, from the remote device that has transitioned to a radio resource control connected state, a release from relaying essential system information originating at the serving network device. The method may include relaying, to the serving network device, a second request for at least one system information block received from the remote device. The method may include relaying, to the remote device that is in the radio resource control connected state, a response containing the at least one system information received from the serving network device.

Some implementations of the method and apparatuses described herein may include receiving essential system information from a serving network device. Some implementations may further include relaying, via a sidelink communication channel, the essential system information, to a remote user device. Some implementations may further include receiving, from the remote user device, a release from relaying essential system information, the remote user device transitioning to a radio resource control connected state. Some implementations may further include, in response to receiving updated essential system information from the serving network device, relaying, via the sidelink communication channel, the updated essential system information, to the remote user device while the remote user device is in the radio resource control connected state.

Some implementations of the method and apparatuses described herein may further include receiving, via a sidelink communication channel from a relay user device, essential system information that originated at a serving network device. Some implementations may further include, in response to transitioning to a radio resource control connected state, foregoing transmitting a release from relaying essential system information to the relay user device. Some implementations may further include, while in the radio resource control connected state, receiving, via the sidelink communication channel from the relay user device, updated essential system information that originated at the serving network device.

Some implementations of the method and apparatuses described herein may further include transmitting by a network device, to an intermediary device, essential system information addressed to a remote user device that is communicatively coupled via a sidelink communication channel to the intermediary device. Some implementations of the method and apparatuses described herein may further include, in response to determining that the remote user device has transitioned to a radio resource control connected state, transmitting, by the network device, updated essential system information to the remote user device via a direct connection corresponding to the radio resource control connected state.

In one or more embodiments, some implementations further include determining that the remote user device has transitioned to the radio resource control connected state based on receiving a dedicated system information block request from the remote user device. In one or more embodiments, some implementations further include determining that the remote user device has transitioned to the radio resource control connected state based on receiving a request for required essential system information via user equipment assistance information message.

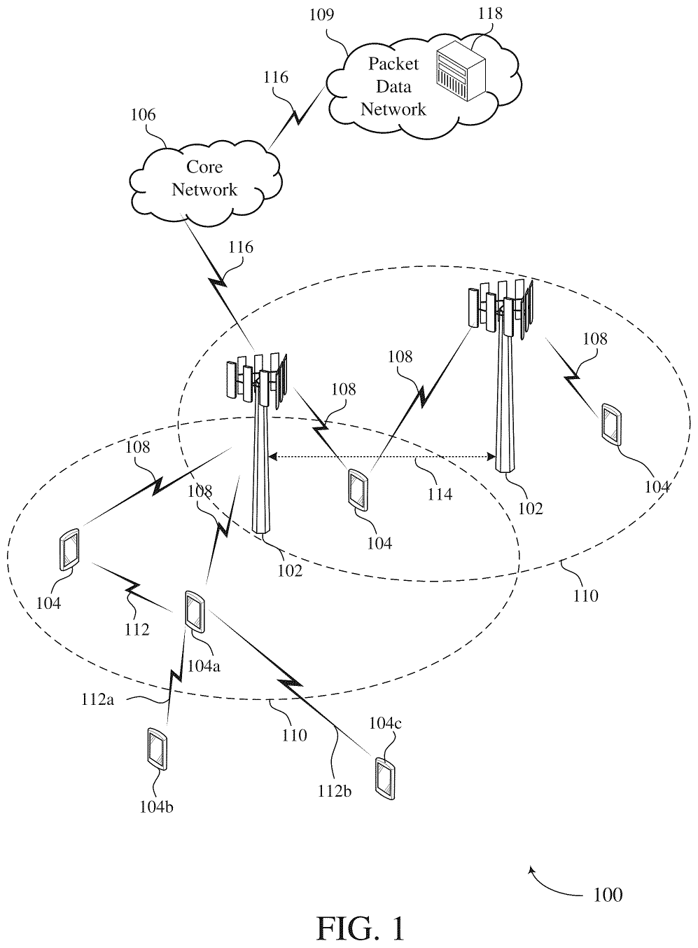

FIG. 1 illustrates an example of a wireless communications system 100 that supports wireless communication of essential system information using sidelink communication relayed to a remote user device even after the remote user device transitions to a radio resource control connected state in accordance with aspects of the present disclosure. The wireless communications system 100 may include one or more base stations or network devices 102, one or more UEs 104, a core network 106, and a packet data network 109. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network devices 102 may be dispersed throughout a geographic region to form the wireless communications system 100. One or more of the network devices 102 described herein may be or include or may be referred to as a base transceiver station, an access point, a NodeB, an eNodeB (eNB), a next-generation NodeB (gNB), or other suitable terminology. A network device 102 and a UE 104 may communicate via a communication link 108, which may be a wireless or wired connection. For example, a network device 102 and a UE 104 may wireless communication over a Uu interface.

A network device 102 may provide a geographic coverage area 110 for which the network device 102 may support services (e.g., voice, video, packet data, messaging, broadcast, etc.) for one or more UEs 104 within the geographic coverage area 110. For example, a network device 102 and a UE 104 may support wireless communication of signals related to services (e.g., voice, video, packet data, messaging, broadcast, etc.) according to one or multiple radio access technologies. In some implementations, a network device 102 may be moveable, for example, a satellite associated with a non-terrestrial network. In some implementations, different geographic coverage areas 110 associated with the same or different radio access technologies may overlap, but the different geographic coverage areas 110 may be associated with different network devices 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network devices 102, other UEs 104, or network equipment (e.g., the core network 106, a relay device, an integrated access and backhaul (IAB) node, or another network equipment), as shown in FIG. 1. Additionally, or alternatively, a UE 104 may support communication with other network devices 102 or UEs 104, by acting as a relay UE relaying information between the network device 102 and the other UEs 104 within the wireless communications system 100.

A UE 104 may also be able to support wireless communication directly with other UEs 104 over a communication link 112. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 112 may be referred to as a sidelink. For example, a UE 104 may support wireless communication directly with another UE 104 over a PC5 interface. In an example, relay UE 104a has a PC5-RRC connection on communication link 112a with remote UE 104b that is outside of coverage areas 110. Relay UE 104a has a PC5-RRC connection on communication link 112b with remote UE 104c that is outside of coverage areas 110. One or more of network device 102, relay UE 104a, and remote UEs 104b-104c are configured to support respectively transmitting, relaying, or receiving updated essential SI even when one or both of remote UEs 104b-104c are in RRC_Connected state. Remote UEs 104b-104c are able to access and connect to the network device 102 using the essential SI such as SIB1.

A network device 102 may support communications with the core network 106, or with another network device 102, or both. For example, a network device 102 may interface with the core network 106 through one or more backhaul links 114 (e.g., via an S1, N2, N2, or another network interface). The network devices 102 may communication with each other over the backhaul links 114 (e.g., via an X2, Xn, or another network interface). In some implementations, the network devices 102 may communicate with each other directly (e.g., between the network devices 102). In some other implementations, the network devices 102 may communicate with each other or indirectly (e.g., via the core network 106). In some implementations, one or more network devices 102 may include subcomponents, such as an access network entity, which may be an example of an access node controller (ANC). An ANC may communication with the one or more UEs 104 through one or more other access network transmission entities, which may be referred to as a radio heads, smart radio heads, or transmission-reception points (TRPs).

In some implementations, a network entity or network device 102 may be configured in a disaggregated architecture, which may be configured to utilize a protocol stack physically or logically distributed among two or more network entities or network devices 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity or network device 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities or network devices 102 in a disaggregated RAN architecture may be co-located, or one or more components of the network entities or network devices 102 may be located in distributed locations (e.g., separate physical locations). In some implementations, one or more network entities or network devices 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities or network devices 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management for the one or more UEs 104 served by the one or more network devices 102 associated with the core network 106.

The core network 106 may communicate with the packet data network 109 over one or more backhaul links 116 (e.g., via an S1, N2, N2, or another network interface). The packet data network 109 may include an application server 118. In some implementations, one or more UEs 104 may communicate with the application server 118. A UE 104 may establish a session (e.g., a protocol data unit (PDU) session, or the like) with the core network 106 via a network entity or network device 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities or network devices 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the network entities or network devices 102 and the UEs 104 may support different resource structures. For example, the network entities or network devices 102 and the UEs 104 may support different frame structures. In some implementations, such as in 4G, the network entities or network devices 102 and the UEs 104 may support a single frame structure. In some other implementations, such as in 5G and among other suitable radio access technologies, the network entities or network devices or network devices 102 and the UEs 104 may support various frame structures (i.e., multiple frame structures). The network entities or network devices 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FRI (410 MHz-7.125 GHZ), FR2 (24.25 GHz-52.6 GHZ), FR3 (7.125 GHz-24.25 GHZ), FR4 (52.6 GHz-114.25 GHZ), FR4a or FR4-1 (52.6 GHz-71 GHZ), and FR5 (114.25 GHz-300 GHz). In some implementations, the network entities or network devices 102 and the UEs 104 may perform wireless communications over one or more of the operating frequency bands. In some implementations, FRI may be used by the network entities or network devices 102 and the UEs 104, among other equipment or devices for cellular communications traffic (e.g., control information, data). In some implementations, FR2 may be used by the network entities or network devices 102 and the UEs 104, among other equipment or devices for short-range, high data rate capabilities.

FRI may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

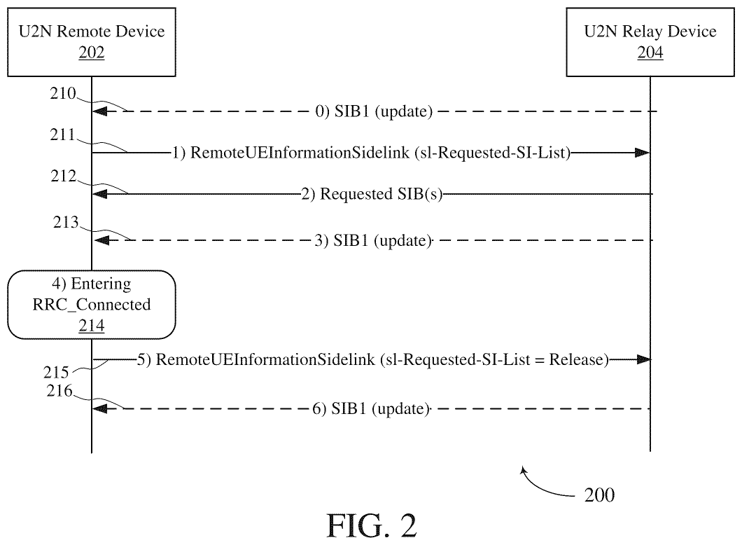

FIG. 2 illustrates a messaging diagram 200 between a U2N remote device 202 such as UEs 104b-104c (FIG. 1) and a U2N relay device 204 such as UE 104a (FIG. 1). In a first aspect, U2N relay device 204 is configured to relay, via sidelink communication, essential system information to the remote device 202 even after being released from relaying the essential system information by the remote device 202 when the remote device 202 is transitioning to an RRC connected state. SIB1 is continued to be forwarded from the relay device 204 to the remote device 202 even if the remote device 202 has “released” the SIB(s) requested (i.e., has set the sl-Requested-SI-List to the value release).

At 210, U2N relay device 204 may provide SIB1 and its update to the U2N remote device 202. At 211, remote device 202 requests other SIB(s) explicitly. In an example, the request is in a form of RemoteUEInformationSidelink (sl-Requested-SI-List). After receiving the SIB request, U2N relay device 204 will acquire the requested SIB(s). At 212, relay device 204 thereafter forwards these requested SIB(s) to the remote device 202. At 213, relay device 204 may relay updated SIB1. At 214, remote device 202 enters RRC_Connected state. At 215, in response to the RRC_Connected state, remote device 202 informs the relay device 204 that no SIB(s) are requested anymore by sending the RemoteUEInformationSidelink message and setting the included sl-Requested-SI-List to the value “release”. At 216, as part of this embodiment, the U2N relay device 204 is configured to still keep forwarding SIB1 updates to the remote device 202 even after having received the message at 215.

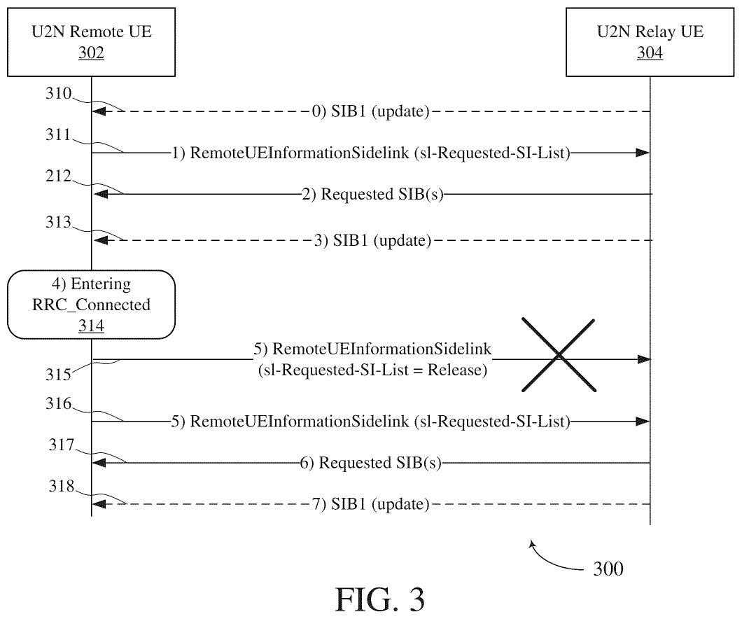

FIG. 3 illustrates a messaging diagram 300 between a U2N remote device 302 such as UEs 104b-104c (FIG. 1) and a U2N relay device 304 such as UE 104a (FIG. 1). In a second aspect, U2N remote device 302 is configured when transitioning to an RRC connected state not to release the U2N relay device 304, via sidelink communication, from relaying essential system information to the remote device 302.

At 310, U2N relay device 304 may provide SIB1 and its update to the U2N remote device 302. At 311, remote device 302 requests other SIB(s) explicitly. In an example, the request is in a form of RemoteUEInformationSidelink (sl-Requested-SI-List). After receiving the SIB request, U2N relay device 304 will acquire the requested SIB(s). At 312, relay device 304 thereafter forwards these requested SIB(s) to the remote device 302. At 313, relay device 304 may relay updated SIB1. At 314, remote device 302 enters RRC_Connected state. At 315, remote device 202 is configured not to inform the relay device 304 that no SIB(s) are requested anymore. Remote device 302 does not send a RemoteUEInformationSidelink message with the included sl-Requested-SI-List set to the value “release”. Instead, at 316, remote device 302 may send RemoteUEInformationSidelink message (sl-Requested-SI-List) requesting only SIB(s) that the remote device 302 might need in RRC_Connected state from the relay device 304. At 317, U2N relay device 304 relays the requested SIB(s). At 318, U2N relay device 204 relays the SIB1 updates. Depending on availability of the SIB1 updates, U2N relay device 204 may relay the SIB1 updates before or after the requested SIB(s).

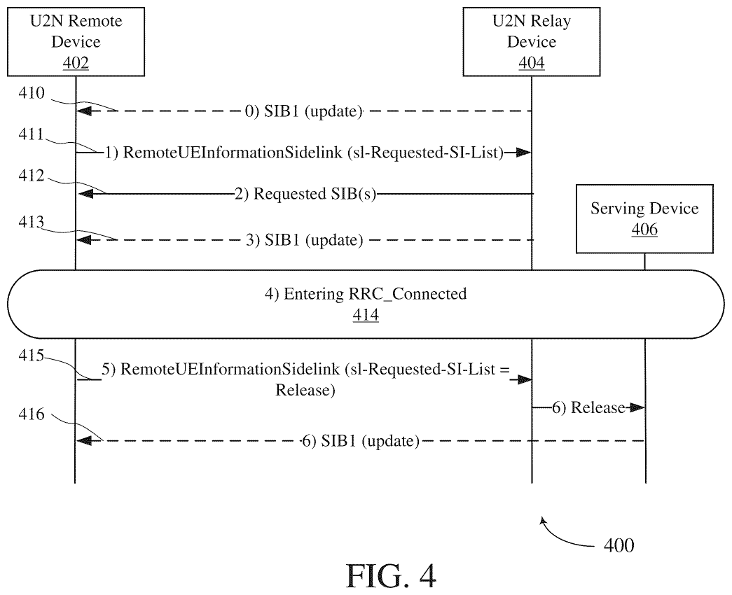

FIG. 4 illustrates a messaging diagram 400 between a U2N remote device 402 such as UEs 104b-104c (FIG. 1), a U2N relay device 404 such as UE 104a (FIG. 1), and a serving device 406, such as network device 102 (FIG. 1). In a third aspect, the serving device 406 is configured to distribute essential system information to the U2N remote device 402 such as SIB1 even when the U2N remote device 402 transitions to an RRC connected state.

At 410, U2N relay device 404 may provide SIB1 and its update to the U2N remote device 402. At 411, remote device 402 requests other SIB(s) explicitly. In an example, the request is in a form of RemoteUEInformationSidelink (sl-Requested-SI-List). After receiving the SIB request, U2N relay device 404 will acquire the requested SIB(s). At 412, relay device 404 thereafter forwards these requested SIB(s) to the remote device 402. At 413, relay device 404 may relay updated SIB1. At 414, remote device 402 enters RRC_Connected state. The serving device 406 transmits updated master information block (MIB)/SIB1 to the remote device 402 that is in the RRC connected state. At 415, in response to the RRC_Connected state, remote device 402 informs the relay device 404 that no SIB(s) are requested anymore by sending the RemoteUEInformationSidelink message and setting the included sl-Requested-SI-List to the value “release”. Regardless of the release, the serving device 406 is configured to identify that a certain UE is a U2N remote device 402 since the remote device 402 is connecting via the U2N relay device 404. In an example, the serving device 406 identifies this status based on the presence of a sidelink relay adaptation protocol (SRAP) header. In response, at 416, the serving device 406, ignoring the release, forwards SIB1 updates to the U2N remote device 402.

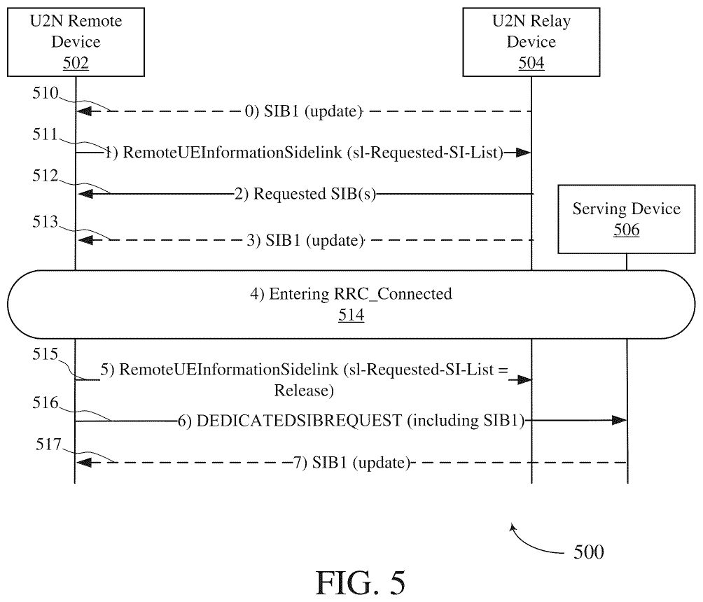

FIG. 5 illustrates a messaging diagram 500 between a U2N remote device 502 such as UEs 104b-104c (FIG. 1), a U2N relay device 504 such as UE 104a (FIG. 1), and a serving device 506, such as network device 102 (FIG. 1). In a fourth aspect, the U2N remote device 502, U2N relay device 504, and serving device 506 are configured to support messaging to distribute essential system information such as SIB1 even when the U2N remote device 502 transitions to an RRC connected state.

At 510, U2N relay device 504 may provide SIB1 and its update to the U2N remote device 502. At 511, remote device 502 requests other SIB(s) explicitly. In an example, the request is in a form of RemoteUEInformationSidelink (sl-Requested-SI-List). After receiving the SIB request, U2N relay device 504 will acquire the requested SIB(s). At 512, relay device 504 thereafter forwards these requested SIB(s) to the remote device 502. At 513, relay device 504 may relay updated SIB1. At 514, remote device 502 enters RRC_Connected state. The serving device 506 transmits updated master information block (MIB)/SIB1 to the remote device 502 that is in the RRC connected state. At 515, in response to the RRC_Connected state, remote device 502 informs the relay device 504 that no SIB(s) are requested anymore by sending the RemoteUEInformationSidelink message and setting the included sl-Requested-SI-List to the value “release”.

Regardless of the release, the serving device 506 is configured to identify that a certain UE is a U2N remote device 502 since the remote device 502 is connecting via the U2N relay device 504. In an example, the serving device 506 identifies this status based on the presence of a sidelink relay adaptation protocol (SRAP) header. At 516, remote device 502 sends SIB-ReqInfo in the DEDICATEDSIBREQUEST message that includes SIB1 or an indication for Essential System Information (MIB and SIB1). At 517 upon receiving SIB1 request (inside DedicatedSIBRequest message) in an uplink RRC message, the serving device 506 can provide SIB1 and its updates as and when these become available in a downlink RRC message.

The ASN.1 message structure for the DedicatedSIBRequest message may be structured as follows:

-- ASN1START
-- TAG-DEDICATEDSIBREQUEST-START

| | |
|---|---|
| DedicatedSIBRequest-r16 ::= | SEQUENCE { |

| | |
|---|---|
| criticalExtensions | CHOICE { |

| | |
|---|---|
| dedicatedSIBRequest-r16 | DedicatedSIBRequest-r16-IEs, |
| criticalExtensionsFuture | SEQUENCE { } |

}
}

| | |
|---|---|
| DedicatedSIBRequest-r16-IEs ::= | SEQUENCE { |

| | |
|---|---|
| onDemandSIB-RequestList-r16 | SEQUENCE { |

| | | |
|---|---|---|
| requestedSIB-List-r16 | SEQUENCE | (SIZE |

| | |
|---|---|
| (1..maxOnDemandSIB-r16)) OF SIB-ReqInfo-r16 | OPTIONAL, |

| | | |
|---|---|---|
| requestedSIB-List-r17 | SEQUENCE | (SIZE |

| | | |
|---|---|---|
| (1..maxOnDemandSIB-r16)) | OF | SIB-ReqInfo-r17 |

OPTIONAL,

| | | |
|---|---|---|
| requestedPosSIB-List-r16 | SEQUENCE | (SIZE |

| | | |
|---|---|---|
| (1..maxOnDemandPosSIB-r16)) | OF | PosSIB-ReqInfo-r16 |

OPTIONAL
} OPTIONAL,

| | | |
|---|---|---|
| lateNonCriticalExtension | OCTET STRING | OPTIONAL, |

| | | |
|---|---|---|
| nonCriticalExtension | SEQUENCE { } | OPTIONAL |

}

| | |
|---|---|
| SIB-ReqInfo-r16 ::= | ENUMERATED { sib12, sib13, sib14, |

sib20-v1700, sib21-v1700, spare3, spare2, spare1 }

| | |
|---|---|
| SIB-ReqInfo-r17 ::= | ENUMERATED { sib12, sib13, sib14, sib20- |

v1700, sib21-v1700, sib1, spare2, spare1 }

| | |
|---|---|
| PosSIB-ReqInfo-r16 ::= | SEQUENCE { |

| | |
|---|---|
| gnss-id-r16 | OPTIONAL, |
| sbas-id-r16 | OPTIONAL, |
| posSibType-r16 | ENUMERATED { posSibType1-1, |

posSibType1-2, posSibType1-3, posSibType1-4, posSibType1-5,
posSibType1-6,

| | |
|---|---|
| posSibType1-7, | posSibType1-8, |

posSibType2-1, posSibType2-2, posSibType2-3, posSibType2-4,

| | |
|---|---|
| posSibType2-5, | posSibType2-6, |

posSibType2-7, posSibType2-8, posSibType2-9, posSibType2-10,

| | |
|---|---|
| posSibType2-11, | posSibType2-12, |

posSibType2-13, posSibType2-14, posSibType2-15,

| | |
|---|---|
| posSibType2-16, | posSibType2-17, |

posSibType2-18, posSibType2-19, posSibType2-20,

| | |
|---|---|
| posSibType2-21, | posSibType2-22, |

posSibType2-23, posSibType3-1, posSibType4-1,

| | |
|---|---|
| posSibType5-1, | posSibType6-1, |

posSibType6-2, posSibType6-3,... }
}
-- TAG-DEDICATEDSIBREQUEST-STOP
-- ASN1STOP

In a fifth aspect, the UE requests the gNB for required Essential system information (MIB, STB1) using a UAI (UEAssistanceInformation). This embodiment is the same as the previous one except that in this embodiment the SIB1 request is made using UEAssistanceInformation instead of the DedicatedSIBRequest message.

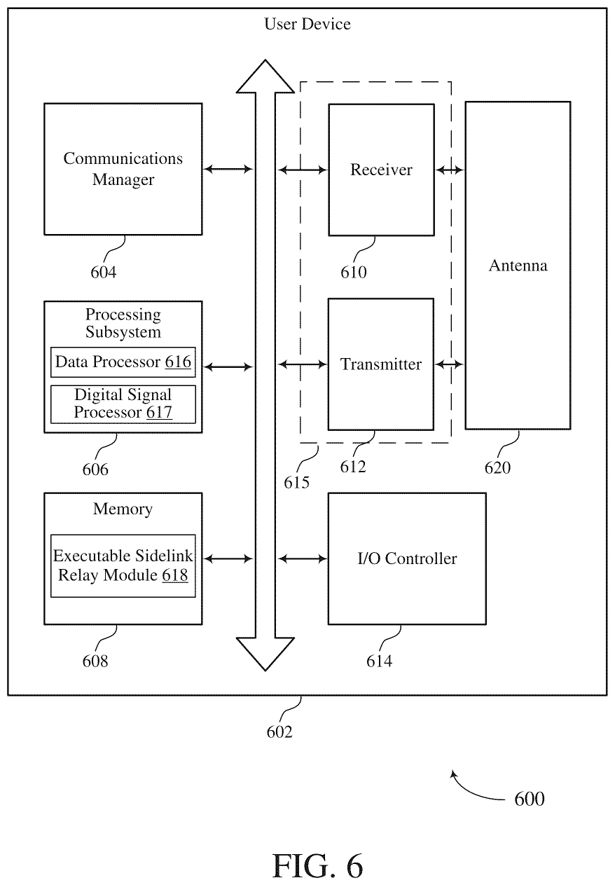

FIG. 6 illustrates an example of a block diagram 600 of a user device 602 that utilizes sidelink communication to relay or receive essential system information such as SIB1, in accordance with aspects of the present disclosure. While operating as a relay communication device, the user device 602 may relay the essential system information to a remote UE that is in RRC connected state. While operating as a remote communication device, user device 602 nay receive the essential system information from the relay UE even while the user device 602 is in a radio resource control (RRC) connected state, in accordance with aspects of the present disclosure. The user device 602 may be an example of a UE 104 as described herein. The user device 602 may support wireless communication with one or more network devices 102, UEs 104, or any combination thereof. The user device 602 may include components for bi-directional communications including components for transmitting and receiving communications, such as a communications manager 604, a processing subsystem 606, a memory 608, a receiver 610, a transmitter 612, and an I/O controller 614. These components may be in electronic communication or otherwise coupled (e.g., operatively, communicatively, functionally, electronically, electrically) via one or more interfaces (e.g., buses). The receiver 610 and transmitter 612 may exist on a same chip and be collectively referred to as a transceiver 615.

The communications manager 604, the receiver 610, the transmitter 612, or various combinations thereof or various components thereof may be examples of means for performing various aspects of the present disclosure as described herein. For example, the communications manager 604, the processing subsystem 606, the receiver 610, the transmitter 612, or various combinations or components thereof may support a method for performing one or more of the functions described herein.

In some implementations, the communications manager 604, the receiver 610, the transmitter 612, or various combinations or components thereof may be implemented in hardware (e.g., in communications management circuitry). The hardware may include a data processor 616, a digital signal processor (DSP) 617, an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processing subsystem 606 and the memory 608 coupled with the processing subsystem 606 may be configured to perform one or more of the functions described herein (e.g., by executing, by the processing subsystem 606, instructions stored in the memory 608). In an example, executable sidelink relay module 618 stored in memory 608 and executed by processing subsystem 606 configures the user device 602 to relay or receive essential system information while transitioning to and being in a radio resource control (RRC) connected state.

Additionally, or alternatively, in some implementations, the communications manager 604, the receiver 610, the transmitter 612, or various combinations or components thereof may be implemented in code (e.g., as communications management software or firmware) executed by the processing subsystem 606. If implemented in code executed by the processing subsystem 606, the functions of the communications manager 604, the receiver 610, the transmitter 612, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the communications manager 604 may be configured to perform various operations (e.g., receiving, monitoring, transmitting) using or otherwise in cooperation with the receiver 610, the transmitter 612, or both. For example, the communications manager 604 may receive information from the receiver 610, send information to the transmitter 612, or be integrated in combination with the receiver 610, the transmitter 612, or both to receive information, transmit information, or perform various other operations as described herein. Although the communications manager 604 is illustrated as a separate component, in some implementations, one or more functions described with reference to the communications manager 604 may be supported by or performed by the processing subsystem 606, the memory 608, or any combination thereof. For example, the memory 608 may store code, which may include instructions executable by the processing subsystem 606 to cause the user device 602 to perform various aspects of the present disclosure as described herein, or the processing subsystem 606 and the memory 608 may be otherwise configured to perform or support such operations.

For example, the communications manager 604 may support wireless communication at a first device (e.g., the user device 602) in accordance with examples as disclosed herein. The communications manager 604 may be configured as or otherwise support wireless communication using sidelink communication in unlicensed spectrum. In particular, the processing subsystem 606 configures the communications manager 604 and transceiver 615 to support sidelink wireless communication relaying or receiving essential system information from a serving network device, with device 602 utilized as either the relay device or the remote device.

The processing subsystem 606 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processing subsystem 606 may be configured to operate a memory array using a memory controller. In some other implementations, a memory controller may be integrated into the processing subsystem 606. The processing subsystem 606 may be configured to execute computer-readable instructions stored in a memory (e.g., the memory 608) to cause/configure the user device 602 to perform various functions of the present disclosure.

The memory 608 may include random access memory (RAM) and read-only memory (ROM). The memory 608 may store computer-readable, computer-executable code including instructions that, when executed by the processing subsystem 606 cause the user device 602 to perform various functions described herein. The code may be stored in a non-transitory computer-readable medium such as system memory or another type of memory. In some implementations, the code may not be directly executable by the processing subsystem 606 but may cause/configure a computer (e.g., when the code is compiled and executed) to perform functions described herein. In some implementations, the memory 608 may include, among other things, a basic I/O system (BIOS) which may control basic hardware or software operation such as the interaction with peripheral components or devices.

The I/O controller 614 may manage input and output signals for the user device 602. The I/O controller 614 may also manage peripherals not integrated into the user device 602. In some implementations, the I/O controller 614 may represent a physical connection or port to an external peripheral. In some implementations, the I/O controller 614 may utilize an operating system such as iOS®, ANDROID®, MS-DOS®, MS-WINDOWS®, OS/2®, UNIX®, LINUX®, or another known operating system. In some implementations, the I/O controller 614 may be implemented as part of a processor, such as the processing subsystem 606. In some implementations, a user may interact with the user device 602 via the I/O controller 614 or via hardware components controlled by the I/O controller 614.

In some implementations, the user device 602 may include a single antenna 620. However, in some other implementations, the user device 602 may have more than one antenna 620, which may be capable of concurrently transmitting or receiving multiple wireless transmissions. The receiver 610 and the transmitter 612 may communicate bi-directionally, via the one or more antennas 620, wired, or wireless links as described herein. For example, the receiver 610 and the transmitter 612 may represent a wireless transceiver and may communicate bi-directionally with another wireless transceiver. The transceiver may also include a modem to modulate the packets, to provide the modulated packets to one or more antennas 620 for transmission, and to demodulate packets received from the one or more antennas 620.

In one or more embodiments, the user device 602 performs wireless communication as a relay device or intermediary device such as UE 104a for remote user devices such as UEs 104b-104c of FIG. 1. UEs 104a-104c may incorporate components and functionality of user device 602 (FIG. 6). The user device 602 receives essential system information from a serving network device. The user device 602 relays, via a sidelink communication channel, the essential system information, to a remote user device. The user device 602 receives, from the remote user device, a release from relaying essential system information After/when the remote user device transitions to a radio resource control connected state. In response to receiving updated essential system information from the serving network device, the user device 602 relays, via the sidelink communication channel, the updated essential system information, to the remote user device while the remote user device is in the radio resource control connected state.

In one or more embodiments, the user device 602 performs wireless communication as a remote device such as UEs 104b-104c of FIG. 1 that is supported by an intermediary device or relay device such as UE 104a of FIG. 1. The user device 602 receives, via a sidelink communication channel from a relay user device, essential system information that originated at a serving network device. In one or more embodiments, in response to transitioning to a radio resource control connected state, the user device 602 foregoes transmitting a release from relaying essential system information to the relay user device. While in the radio resource control connected state, the user device 602 receives, via the sidelink communication channel from the relay user device, updated essential system information that originated at the serving network device.

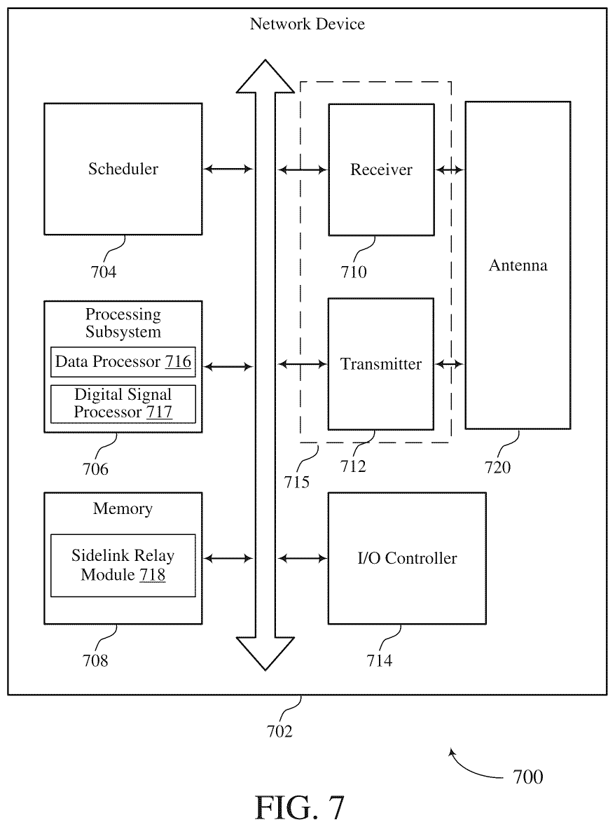

FIG. 7 illustrates an example of a block diagram 700 of a network device 702 that supports sidelink wireless communication that distributes essential system information such as SIB1, in accordance with aspects of the present disclosure. The network device 702 may transmit the essential system information via a relay UE to a remote UE before and after transitioning to a radio resource control (RRC) connected state. The network device 702 may be an example of a network device 102 or a base node, as described herein. The network device 702 may support wireless communication with one or more network devices 102 and core network 106 as described in FIG. 1, UEs 104, or any combination thereof. The network device 702 may include components for bi-directional communications including components for transmitting and receiving communications, such as a scheduler 704, a processing subsystem 706, a memory 708, a receiver 710, transmitter 712, and an I/O controller 714. These components may be in electronic communication or otherwise coupled (e.g., operatively, communicatively, functionally, electronically, electrically) via one or more interfaces (e.g., buses). The receiver 710 and transmitter 712 may be located on a single chip and collectively referred to as a transceiver 715.

The scheduler 704, the receiver 710, the transmitter 712, or various combinations thereof or various components thereof may be examples of means for performing various aspects of the present disclosure as described herein. For example, the scheduler 704, the receiver 710, the transmitter 712, or various combinations or components thereof may support a method for performing one or more of the functions described herein.

In some implementations, the scheduler 704, the receiver 710, the transmitter 712, or various combinations or components thereof may be implemented in hardware (e.g., in communications management circuitry). The hardware may include a processor 716, a digital signal processor (DSP) 717, an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processing subsystem 706 and the memory 708 coupled with the processing subsystem 706 may be configured to perform one or more of the functions described herein (e.g., by executing, by the processing subsystem 706, instructions stored in the memory 708).

Additionally, or alternatively, in some implementations, the scheduler 704, the receiver 710, the transmitter 712, or various combinations or components thereof may be implemented in code (e.g., as communications management software or firmware) executed by the processing subsystem 706. If implemented in code executed by the processing subsystem 706, the functions of the scheduler 704, the receiver 710, the transmitter 712, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the scheduler 704 may be configured to perform various operations (e.g., receiving, monitoring, transmitting) using or otherwise in cooperation with the receiver 710, the transmitter 712, or both. For example, the scheduler 704 may receive information from the receiver 710, send information to the transmitter 712, or be integrated in combination with the receiver 710, the transmitter 712, or both—to receive information, transmit information, or perform various other operations as described herein. Although the scheduler 704 is illustrated as a separate component, in some implementations, one or more functions described with reference to the scheduler 704 may be supported by or performed by the processing subsystem 706, the memory 708, or any combination thereof. For example, the memory 708 may store code, which may include instructions executable by the processing subsystem 706 to cause/configure the network device 702 to perform various aspects of the present disclosure as described herein, or the processing subsystem 706 and the memory 708 may be otherwise configured to perform or support such operations.

For example, the scheduler 704 may support wireless communication at a first network device (e.g., the network device 702) in accordance with examples as disclosed herein. The scheduler 704 may be configured support wireless communication of essential system information with a relay communication device that relays via a sidelink communication channel. In particular, the processing subsystem 706 configures the scheduler 704 and transceiver 715 to perform wireless communication.

The processing subsystem 706 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processing subsystem 706 may be configured to operate a memory array using a memory controller. In some other implementations, a memory controller may be integrated into the processing subsystem 706. The processing subsystem 706 may be configured to execute computer-readable instructions stored in a memory (e.g., the memory 708) to cause the network device 702 to perform various functions of the present disclosure.

The memory 708 may include random access memory (RAM) and read-only memory (ROM). The memory 708 may store computer-readable, computer-executable code including instructions that, when executed by the processing subsystem 706 cause the network device 702 to perform various functions described herein. The code may be stored in a non-transitory computer-readable medium such as system memory or another type of memory. In some implementations, the code may not be directly executable by the processing subsystem 706 but may cause/configure a computer (e.g., when compiled and executed) to perform functions described herein. In some implementations, the memory 708 may include, among other things, a basic I/O system (BIOS) which may control basic hardware or software operation such as the interaction with peripheral components or devices. The network device 702 may store an executable sidelink relay module 718 that when executed configures the network device 702 to transmit essential system information to a relaying UE that is relayed via sidelink communication to a remote UE that is in a radio resource control (RRC) connected state.

The I/O controller 714 may manage input and output signals for the network device 702. The I/O controller 714 may also manage peripherals not integrated into the network device 702. In some implementations, the I/O controller 714 may represent a physical connection or port to an external peripheral. In some implementations, the I/O controller 714 may utilize an operating system such as iOS®, ANDROID®, MS-DOS®, MS-WINDOWS®, OS/2®, UNIX®, LINUX®, or another known operating system. In some implementations, the I/O controller 714 may be implemented as part of a processor, such as the processing subsystem 706. In some implementations, a user may interact with the network device 702 via the I/O controller 714 or via hardware components controlled by the I/O controller 714.

In some implementations, the network device 702 may include a single antenna 720. However, in some other implementations, the network device 702 may have more than one antenna 720, which may be capable of concurrently transmitting or receiving multiple wireless transmissions. The receiver 710 and the transmitter 712 may communicate bi-directionally, via the one or more antennas 720, wired, or wireless links as described herein. For example, the receiver 710 and the transmitter 712 may represent a wireless transceiver and may communicate bi-directionally with another wireless transceiver. The transceiver may also include a modem to modulate the packets, to provide the modulated packets to one or more antennas 720 for transmission, and to demodulate packets received from the one or more antennas 720.

In one or more embodiments, the network device 702 performs wireless communication as a serving network device for an intermediary device such as UE 104a and for remote user devices such as UEs 104b-104c of FIG. 1. UEs 104a-104c may incorporate components and functionality of user device 602 (FIG. 6). The network device 702 transmits, to an intermediary device, essential system information addressed to a remote user device that is communicatively coupled via a sidelink communication channel to the intermediary device. In response to determining that the remote user device has transitioned to a radio resource control connected state, the network device 702 transmits updated essential system information to the remote user device via a direct connection corresponding to the radio resource control connected state.

In one or more particular embodiments, the network device 702 determines that the remote user device has transitioned to the radio resource control connected state based on receiving a dedicated system information block request from the remote user device. In one or more particular embodiments, the network device 702 determines that the remote user device has transitioned to the radio resource control connected state based on receiving a request for required essential system information via user equipment assistance information message.

According to aspects of the present disclosure, the SIB1 is acquired by a U2N remote UE that is RRC_Connected in the following ways: (a) by a U2N Relay continuing to forward SIB1 updates to the U2N remote UE irrespective of receiving RemoteUEInformationSidelink and without concerning its contents; (b) by U2N remote UE not setting the sl-Requested-SI-List to the value “release” while/after transitioning to RRC_Connected; (c) by the relaying UE ensuring to send SIB1 and its update to all U2N remote UEs; or (d) by using the DedicatedSIBRequest and including an explicit information inside it to allow SIB1 request.

In one or more embodiments, the present disclosure provides a method in a remote UE. The method includes initiating transition by the remote UE to RRC_connected state. The method includes sending a release of requested system information to the relay UE. The method includes sending a dedicated SIB request to the serving network node and including an explicit information inside the dedicated SIB request for a SIB1 request.

In one or more embodiments, the present disclosure provides a method in a network node. The method includes receiving a dedicated SIB request and determining if an explicit request for SIB1 is made by a U2N remote UE. The method includes transmitting SIB1 to the RRC connected U2N Remote UE.

In one or more embodiments, the present disclosure provides a method in a network node. The method includes determining if a RRC connected UE is a U2N remote UE. The method includes transmitting SIB1 to the RRC Connected U2N remote UE.

The present disclosure addresses situations when a relay UE will not provide SIB1 to a remote UE once the remote UE has released the request to forward SIB(s) when entering an RRC_connected state. Otherwise, the remote UE, when unable to receive SIB1 updates, will continue to use the version of SIB1 that can become stale, indicating an invalid configuration. In an example, ServingCellConfigCommonSIB containing SSB information is needed for the remote UE to monitor the radio condition with the serving cell. In the RRC_connected state, the present disclosure provides for a remote UE to request SIB1. Thereby, a U2N remote UE is able to maintain a valid version of SIB1 after having transitioned to RRC_connected state. In one or more embodiments, the present disclosure provides a new relay UE behavior whereby the U2N relay device continues to forward SIB1 updates to a U2N remote UE irrespective of receiving RemoteUEInformationSidelink and irrespective of the contents of the RemoteUEInformationSidelink. In one embodiment, SIB1 is continued to be forwarded from the relay UE to the remote UE even if the remote device has “released” the SIB(s) requested (i.e., has set the sl-Requested-SI-List to the value release). In another embodiment, the serving gNB transmits updated MIB/SIB1 to an RRC_connected remote UE.

It should be noted that the methods described herein describes possible implementations, and that the operations and the steps may be rearranged or otherwise modified and that other implementations are possible. Further, aspects from two or more of the methods may be combined.

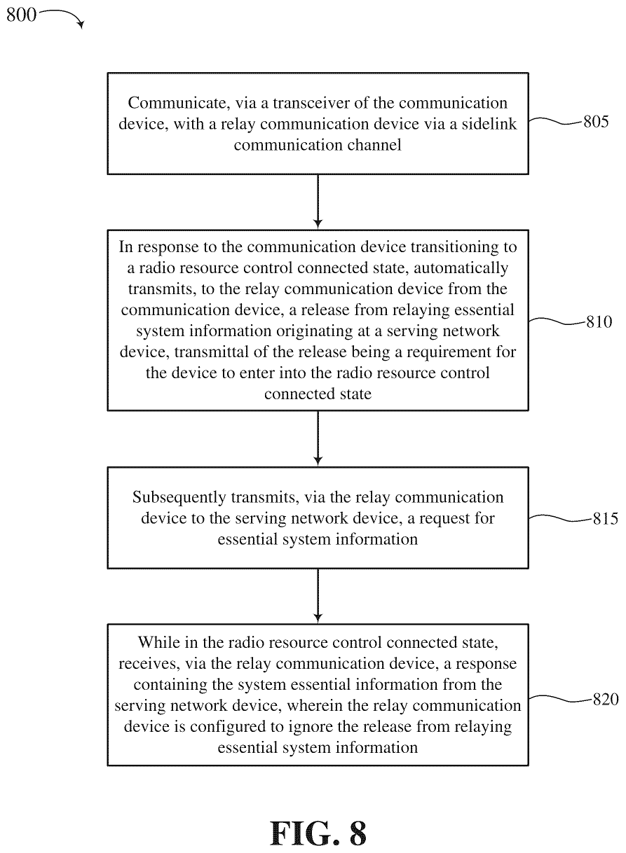

FIG. 8 illustrates a flowchart of a method 800 that supports wireless communication at a remote communication device that continues to receive essential system information using sidelink communication while in a radio resource control connected state, in accordance with aspects of the present disclosure. The operations of the method 800 may be implemented by a device or its components as described herein. For example, the operations of the method 800 may be performed by a user device such as UE 104 (FIG. 1) or device 602 as described with reference to FIG. 6. In some implementations, the user device may execute a set of instructions to control the function elements of the network device to perform the described functions. Additionally, or alternatively, the user device may perform aspects of the described functions using special-purpose hardware.

At 805, the method 800 may include communicating, via a transceiver of the communication device, with a relay communication device via a sidelink communication channel. The operations of 805 may be performed in accordance with examples as described herein. In some implementations, aspects of the operations of 805 may be performed by a device as described with reference to FIG. 1 or 6.

At 810, the method 800 may further include, in response to the communication device transitioning to a radio resource control connected state, automatically transmitting, to the relay communication device from the communication device, a release from relaying essential system information originating at a serving network device, transmittal of the release being a requirement for the device to enter into the radio resource control connected state. The operations of 810 may be performed in accordance with examples as described herein. In some implementations, aspects of the operations of 810 may be performed by a device as described with reference to FIG. 1 or 6.

At 815, the method 800 may further include subsequently transmitting, via the relay communication device to the serving network device, a request for essential system information. The operations of 815 may be performed in accordance with examples as described herein. In some implementations, aspects of the operations of 815 may be performed by a device as described with reference to FIG. 1 or 6.

At 820, the method 800 may further include, while in the radio resource control connected state, receiving, via the relay communication device, a response containing the system essential information from the serving network device, wherein the relay communication device and the serving network node are configured to ignore the release from relaying essential system information. The operations of 820 may be performed in accordance with examples as described herein. In some implementations, aspects of the operations of 820 may be performed by a device as described with reference to FIG. 1 or 6.

According to one or more embodiments, the method 800 may include further transmitting before the device enters the radio resource control connected state, via the transceiver to the relay communication device, a first request for system essential information that originates at a serving network device. The request is a second request that is subsequent to the first request. The method 800 may include receiving, from the relay communication device, the system essential information in response to the first request.

In one or more embodiments, the system essential information includes at least one system information block. In one or more embodiments, the first request for the at least one system information block comprises a radio resource control message. In one or more embodiments, the second request for the at least one system information block and the response containing the at least one system information block include radio resource control messages.

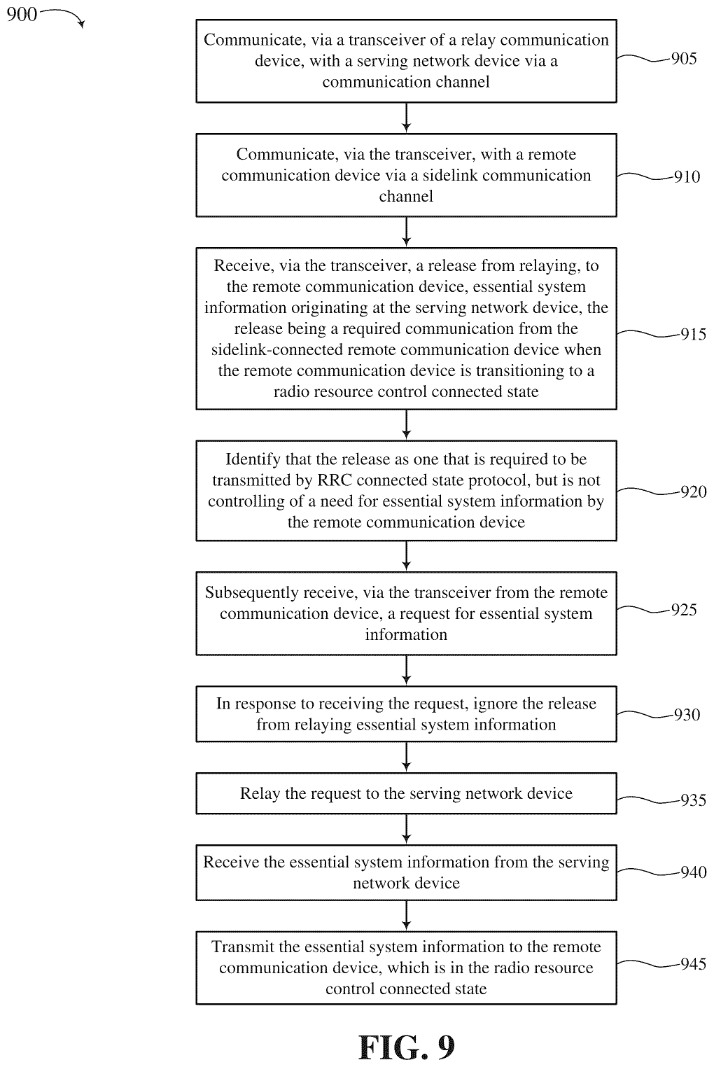

FIG. 9 illustrates a flowchart of a method 900 that supports wireless communication at a relay communication device that continues to relay essential system information using sidelink communication while a remote communication device is in a radio resource control connected state, in accordance with aspects of the present disclosure. The operations of the method 900 may be implemented by a device or its components as described herein. For example, the operations of the method 900 may be performed by a user device such as UE 104 (FIG. 1) or device 602 as described with reference to FIG. 6. In some implementations, the user device may execute a set of instructions to control the function elements of the network device to perform the described functions. Additionally, or alternatively, the user device may perform aspects of the described functions using special-purpose hardware.

At 905, the method 900 may include communicating, via a transceiver of a relay communication device, with a serving network device via a communication channel. The operations of 905 may be performed in accordance with examples as described herein. In some implementations, aspects of the operations of 905 may be performed by a device as described with reference to FIG. 1 or 6.

At 910, the method 900 may further include communicating, via the transceiver, with a remote communication device via a sidelink communication channel. The operations of 910 may be performed in accordance with examples as described herein. In some implementations, aspects of the operations of 910 may be performed by a device as described with reference to FIG. 1 or 6.

At 915, the method 900 may further include receiving, via the transceiver, a release from relaying, to the remote communication device, essential system information originating at the serving network device. The release is a required communication from the sidelink-connected remote communication device when the remote communication device is transitioning to a radio resource control connected state. The operations of 915 may be performed in accordance with examples as described herein. In some implementations, aspects of the operations of 915 may be performed by a device as described with reference to FIG. 1 or 6.

At 920, the method 900 may further include identifying that the release as one that is required to be transmitted by RRC connected state protocol but is not controlling of a need for essential system information by the remote communication device. The operations of 920 may be performed in accordance with examples as described herein. In some implementations, aspects of the operations of 920 may be performed by a device as described with reference to FIG. 1 or 6.

At 925, the method 900 may further include subsequently receiving, via the transceiver from the remote communication device, a request for essential system information. The operations of 925 may be performed in accordance with examples as described herein. In some implementations, aspects of the operations of 925 may be performed by a device as described with reference to FIG. 1 or 6.

At 930, the method 900 may further include, in response to receiving the request, ignoring the release from relaying essential system information. The operations of 930 may be performed in accordance with examples as described herein. In some implementations, aspects of the operations of 930 may be performed by a device as described with reference to FIG. 1 or 6.

At 935, the method 900 may further include relaying the request to the serving network device. The operations of 935 may be performed in accordance with examples as described herein. In some implementations, aspects of the operations of 935 may be performed by a device as described with reference to FIG. 1 or 6.

At 940, the method 900 may further include receiving the essential system information from the serving network device. The operations of 940 may be performed in accordance with examples as described herein. In some implementations, aspects of the operations of 940 may be performed by a device as described with reference to FIG. 1 or 6.

At 945, the method 900 may further include transmitting the essential system information to the remote communication device, which is in the radio resource control connected state. The operations of 945 may be performed in accordance with examples as described herein. In some implementations, aspects of the operations of 945 may be performed by a device as described with reference to FIG. 1 or 6.

According to aspects of the present disclosure, the request is a second request that is subsequent to a first request. the method 900 may further include receiving, via the transceiver from the remote communication device, the first request for system essential information that originates at a serving network device. The first request is transmitted before the remote communication device enters the radio resource control connected state. The method 900 may further include relaying the first request to the serving network device. The method 900 may further include receiving the essential system information from the serving network device. The method 900 may further include transmitting the system essential information to the remote communication device in response to the first request.

In one or more embodiments, the system essential information includes at least one system information block. In one or more embodiments, the first request for the at least one system information block includes a radio resource control message. In one or more embodiments, the second request for the at least one system information block and the response containing the at least one system information block include radio resource control messages. In one or more embodiments, the controller logs the release.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, the UE comprising:
a transceiver that enables the UE to communicate with a sidelink relay device via a sidelink communication channel; and
a controller communicatively coupled to the transceiver, and which is configured to cause the UE to:
transmit, to the sidelink relay device, a request for at least one system information block (SIB);
receive, from the sidelink relay device, the at least one SIB;
transmit, to the sidelink relay device, an indication releasing relaying of system information by the sidelink relay device;
transmit, to a serving network device, a second request for at least one SIB; and
receive, via the sidelink communication channel from the sidelink relay device, the at least one SIB.

2. The UE of claim 1, wherein the second request that is subsequent to the request, and the controller is configured to cause the UE to:
transmit, via the transceiver to the sidelink relay device, the request as a first request for system information before the device enters the radio resource control connected state; and
receive, from the sidelink relay device, the at least one SIB as the essential system information, in response to the first request.

3. (canceled)

4. The UE of claim 1, wherein the request for the at least one SIB transmitted to the sidelink relay device comprises a radio resource control message.

5. The UE of claim 1, wherein the second request to the serving network device for the at least one SIB and the response containing the at least one SIB from the serving network device comprise radio resource control messages.

6. A method for wireless communication by a user equipment (UE) operating as a sidelink remote device, the method comprising:
transmitting, to a sidelink relay device, a request for at least one system information block (SIB);
receiving, from the sidelink relay device, the at least one SIB;
transmitting, to the sidelink relay device, an indication releasing relaying system information by the sidelink relay device;
transmitting, to a serving network device, a second request for at least one SIB; and
receiving, via a sidelink communication channel from the sidelink relay device, the at least one SIB.

7. The method of claim 6, further comprising:
transmitting, via the transceiver to the sidelink relay device, the request as a first request for system information before the device enters the radio resource control connected state; and
receiving, from the sidelink relay device, the at least one SIB as the system essential information, in response to the first request.

8. (canceled)

9. The method of claim 6, wherein the request for the at least one SIB transmitted to the sidelink relay device comprises a radio resource control message.

10. The method of claim 6, wherein the second request to the serving network device for the at least one SIB and the response containing the at least one SIB from the serving network device comprise radio resource control messages.

11. A user equipment (UE) for wireless communication, the user equipment comprising:
a transceiver that enables the UE to communicate with a serving network device via a communication channel and with a remote UE via a sidelink communication channel; and
a controller communicatively coupled to the transceiver, and which is configured to cause the UE to:
receive, via the transceiver, a release from relaying, to the remote UE, system information originating at the serving network device, the release being a required communication from a sidelink-connected remote UE when the remote UE is transitioning to a radio resource control (RRC) connected state;
identify that the release is one that is required to be transmitted by RRC connected state protocol, but is not controlling of a need for system information by the remote UE;
subsequently receive, via the transceiver from the remote UE, a request for system information; and
in response to receiving the request:
ignore the release from relaying system information;
relay the request to the serving network device;
receive the system information from the serving network device; and
transmit the essential information to the remote UE.

12. The UE of claim 11, wherein the request comprises a second request that is received after a first request, wherein the controller is further configured to cause the UE to:
receive, via the transceiver from the remote UE, the first request for system information that originates at a serving network device, the first request transmitted before the remote device enters the radio resource control connected state;
relay the first request to the serving network device;
receive the system information from the serving network device; and
transmit the system information to the remote device, in response to the first request.

13. The UE of claim 12, wherein the system information comprises at least one system information block (SIB).

14. The UE of claim 13, wherein the first request is for the at least one SIB and comprises a radio resource control message.

15. The UE of claim 13, wherein the second request is for the at least one SIB and the response contains the at least one SIB, wherein the second request and the response comprise radio resource control messages.

16. The UE of claim 11, wherein the controller logs the release.

17. The UE of claim 1, wherein:
the serving network device is a scheduling network device;
transmittal of the release is a requirement for the UE to enter into a radio resource control connected state; and
the sidelink relay device and the serving network device are configured to ignore the release from relaying essential system information

18. The UE of claim 1, wherein the sidelink relay device is a second UE.

19. The UE of claim 1, wherein:
the request for at least one SIB is transmitted as a request for system information;
the system information originates at the serving network device; and
the system information is provided in response to the second request for at least one SIB after the UE enters the radio resource control connected state.

20. The method of claim 6, further comprising:
communicating, via a transceiver of the UE, with the sidelink relay device via a sidelink communication channel.

21. The method of claim 6, wherein:
the sidelink relay device is a second UE;
the serving network device is a scheduling network device;
transmittal of the release is a requirement for the UE to enter into the radio resource control connected state; and
the sidelink relay device and the serving network device are configured to ignore the release from relaying system information.

22. The method of claim 6, wherein:
the request for at least one SIB is transmitted as a request for system information;
the system information originates at the serving network device; and
the system information is provided in response to the second request for at least one SIB after the UE enters the radio resource control connected state.
